(19) United States
(12) Patent Application Publication
(10) Pub. No.: US 2025/0272895 A1
(43) Pub. Date: Aug. 28, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: KENTO MANNEN, Kanagawa (JP)

(21) Appl. No.: 19/057,013

(22) Filed: Feb. 19, 2025

(30) Foreign Application Priority Data
Feb. 22, 2024 (JP) 2024-025402

(51) Int. Cl. G06T 11/60; G06T 3/40

(52) U.S. Cl. CPC G06T 11/60; G06T 3/40

(57) ABSTRACT

An information processing apparatus includes a setting unit configured to set a plurality of areas to be formed on a printed material in original document data of the printed material, an accepting unit configured to accept a selection of a target area from among the plurality of areas set in the original document data and a selection of a template to be applied to the target area, and an applying unit configured to obtain and apply the selected template to the selected target area.

### BACKGROUND OF THE DISCLOSURE

### Cross-Reference to Priority Application

This application claims the benefit of Japanese Patent Application No. 2024-025402, filed Feb. 22, 2024, which is hereby incorporated by reference herein in its entirety.

### Field of the disclosure

The present disclosure relates to an information processing apparatus capable of editing poster contents and the like, an information processing method, and a storage medium.

### Description of the Related Art

There is a technology for utilizing a template at the time of creating original document data for a printed material such as poster contents for posters, flyers, or the like. The templates have multiple objects such as backgrounds, text, figures, and photos laid out in advance, and thus the user can obtain desired original document data with a minimal amount of work by performing editing work such as changing text and selecting a photo based on a template. In addition, application software is also provided for creating poster contents by utilizing such templates, and thus even users who are not familiar with designing can create high quality poster contents that seem to be created by a professional designer.

Conventionally, this type of application software has been intended to create flat printed materials. Therefore, in a case of creating a printed material that is folded for use, such as a folded pamphlet or a folded menu, the user creates the original document data by applying a template to the original document data of the pamphlet in the unfolded state. In this case, one template is applied to the entire original document data, and thus editing operations such as applying a different template to only a partial area have not been possible. On the other hand, Patent Literature 1 (Japanese Patent Laid-Open No. 2000-200270) discloses a technology for rearrangement to be used at the time of changing the paper size of a document, wherein, keeping a constant margin size, a constant comparison is maintained between the shape of the effective area and the shapes of the objects constituting the layout. By applying this technology, it is conceivable that the objects within a template can be rearranged so as to match the size of the area.

However, the technology disclosed in Patent Literature 1 does not anticipate a situation in which multiple areas are formed on a printed material and these multiple areas are to be handled individually, such as a printed material to be folded for use. Therefore, for applying a template for poster contents to such a printed material including multiple areas, a more enhanced function has been required.

An object of the present disclosure is to make it possible to apply a template to each of multiple areas to be formed on a printed material.

### SUMMARY OF THE DISCLOSURE

An information processing apparatus of the present disclosure includes: a setting unit configured to set a plurality of areas to be formed on a printed material in original document data of the printed material; an accepting unit configured to accept a selection of a target area from among the plurality of areas set in the original document data and a selection of a template to be applied to the target area; and an applying unit configured to obtain and apply the selected template to the selected target area.

Further features of the present disclosure will become apparent from the following description of exemplary embodiments with reference to the attached drawings.

### BRIEF DESCRIPTION OF THE DRAWINGS

FIG. 1 is a diagram illustrating an example of the system configuration of an information processing system;

FIG. 2 is a block diagram illustrating the hardware configuration of an information processing apparatus;

FIG. 3 is a block diagram illustrating the software configuration of a Web server;

FIG. 4 is a block diagram illustrating the software configuration of a terminal device;

FIG. 5 is a diagram is a diagram illustrating an example of a conventional editing screen of a poster creation application;

FIG. 6 is a diagram illustrating a configuration for implementing a function of applying a template to a folding area;

FIG. 7 is a diagram illustrating an example of a printed material setup screen;

FIG. 8 is a diagram illustrating an example of an editing screen of a poster creation application of the present embodiment;

FIG. 9A to FIG. 9C are diagrams illustrating an operation procedure for applying a template to a folding area;

FIG. 10A to FIG. 10D are diagrams illustrating an operation procedure subsequent to FIG. 9A to FIG. 9C;

FIG. 11 is a flowchart for explaining a flow of template application processing in the first embodiment;

FIG. 12A and FIG. 12B are diagrams for explaining template resizing;

FIG. 13 is a flowchart showing the processing for changing the size of each object in a template resizing process;

FIG. 14 is a flowchart showing the processing for changing the position of each object in the template resizing process;

FIG. 15 is a diagram illustrating an example of a printed material setup screen in the second embodiment;

FIG. 16A and FIG. 16B are diagrams illustrating an operation procedure in a case where a template is applied to the entire original document data;

FIG. 17 is a flowchart showing a flow of template application processing in the second embodiment;

FIG. 18A to FIG. 18C are diagrams showing information regarding a connection of multiple areas for the outward folding into three areas;

FIG. 19A to FIG. 19C are diagrams showing information regarding a connection of multiple areas for the inward folding into three areas;

FIG. 20A to FIG. 20E are diagrams for explaining a specific operation for selecting multiple areas as one connected area;

FIG. 21A to FIG. 21C are diagrams illustrating an operation procedure in a case where multiple areas are selected as one connected area, to which a template is applied;

FIG. 22A and FIG. 22B are diagrams illustrating an operation procedure subsequent to FIG. 21A to FIG. 21C; and

FIG. 23 is a flowchart showing a flow of template application processing in the third embodiment.

### DESCRIPTION OF THE EMBODIMENTS

Hereafter, with reference to the attached drawings, the present disclosure explains some example embodiments in detail. Configurations shown in the following embodiments are merely exemplary and some embodiments of the present disclosure are not limited to the configurations shown schematically.

Further, multiple characteristics may be combined in any desired manner. Moreover, in the accompanying drawings, the same or similar configurations are assigned with the same reference numbers, so that overlapping explanations are omitted.

### First Embodiment

### <<Hardware Configuration>>

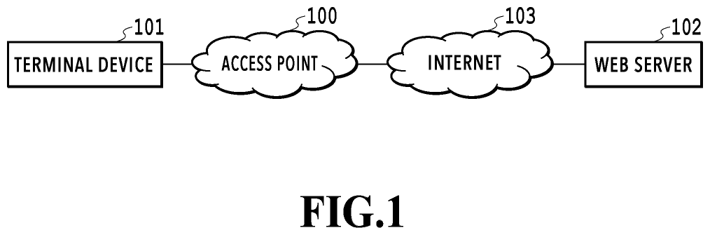

FIG. 1 is a diagram illustrating an example of the configuration of an information processing system including the information processing apparatus of the present embodiment. The information processing system includes the access point 100, the terminal device 101, the Web server 102, and the Internet 103.

The access point 100 functions as a wireless LAN router, for example. The terminal device 101 is connected to the Internet 103 via the access point 100. Therefore, the terminal device 101 is capable of communicating, via the Internet, with the Web server 102 configured for controlling the later-described Web application. Note that the connection form between the terminal device 101 and the access point 100 may be wired or wireless.

The terminal device 101 may be, for example, a personal computer (PC), but may be any information processing apparatus capable of displaying text, performing editing operations, and running programs. For example, the terminal device 101 may be a mobile terminal, a laptop computer, a tablet terminal, a PDA (Personal Digital Assistant), or the like.

The Web server 102 is an information processing apparatus capable of executing a Web server application, and is configured with one or more computers. The Web server 102 is connected to the terminal device 101 via the Internet 103.

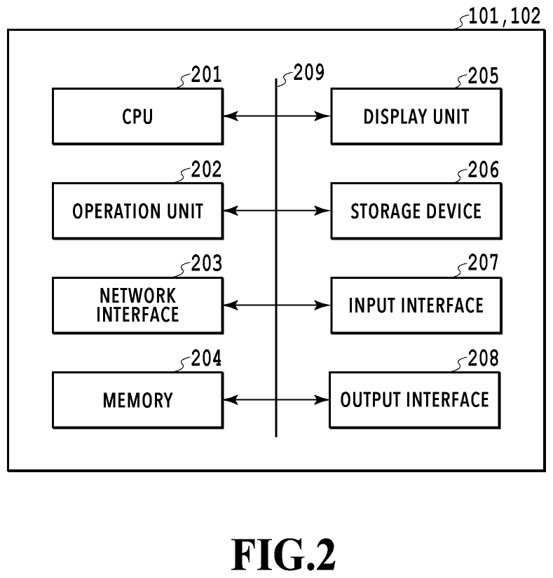

FIG. 2 is a diagram illustrating an example of the hardware configuration of the information processing apparatus utilized as the terminal device 101 and the Web server 102 of the present embodiment. The information processing apparatus includes the CPU 201, the operation unit 202, the network interface 203, the memory 204, the display unit 205, the storage device 206, the input interface 207, and the output interface 208, each of which is connected via the system bus 209. Note that the configuration of the information processing apparatus is not limited to the configuration illustrated in FIG. 2, and the configuration of the apparatus may be changed as appropriate depending on the usage purpose and functions of the information processing apparatus.

The CPU 201 performs overall control of the information processing apparatus. The CPU 201 executes various processes according to programs stored in the storage device 206, using the memory 204 as a work area. Thereby, the functions of the information processing apparatus according to the present disclosure are implemented.

The operation unit 202 is an operation unit that allows the user to give instructions to the information processing apparatus, and includes, for example, buttons and a touch panel. Note that, although FIG. 2 shows an example in which the operation unit 202 is incorporated in the information processing apparatus, it is also possible to connect input devices such as an external keyboard and a pointing device such as a mouse to the input interface 207, so that operations are input from the input devices.

The network interface 203 is an interface for connecting to a network such as a LAN or a WAN. The information processing apparatus can be connected to the access point 100 via a network connected to the network interface 203, and, further, can be connected to the Internet 103 via the access point 100.

The memory 204 is a random access memory (RAM) utilized as a working area for the CPU 201, and is a volatile storage area. The memory 204 is used as a temporary storage area for various pieces of data transmitted and received between the terminal device 101 and the Web server 102, and also stores various kinds of setting data.

The display unit 205 is a display unit that displays various kinds of information input from the CPU 201, and is configured, for example, with a liquid crystal panel, etc. Although FIG. 2 shows an example in which the display unit 205 is incorporated in the information processing apparatus, there is no such limitation to this form. The display unit 205 may be an external display device connected to the system bus 209 via the output interface 208. The liquid crystal panel or external display device is configured with an LED (light emitting diode), an LCD (liquid crystal display), etc., so as to notify the user of data and the status of the information processing apparatus.

The storage device 206 is a non-volatile storage area, and is configured with a ROM, an HDD, an SSD, a flash memory, or the like. The storage device 206 stores the programs relating to the present embodiment, an OS (operating system), various kinds of control programs such as applications, and various kinds of information used by these programs.

The input interface 207 is an interface for accepting data input and operation instructions from the user. The input interface 207 is configured, for example, with a keyboard, a mouse, buttons, a touch panel, and the like. Note that the output interface 208 and the input interface 207, which are described later, may be integrated so that common hardware, such as a touch panel display, is used for both outputting to the screen and receiving operations from the user. In this case, a soft keyboard including keys such as numeral input keys, a mode setting key, a determination key, a cancel key, a power key, and the like may be displayed on the display device, so that input from the user is accepted via the soft keyboard.

The output interface 208 is an interface for connecting peripheral devices such as an external display device or a printer. For example, in a case where an external display device is connected, the output interface 208 outputs control information and display target information for displaying information on the external display.

### <<Software Configuration>>

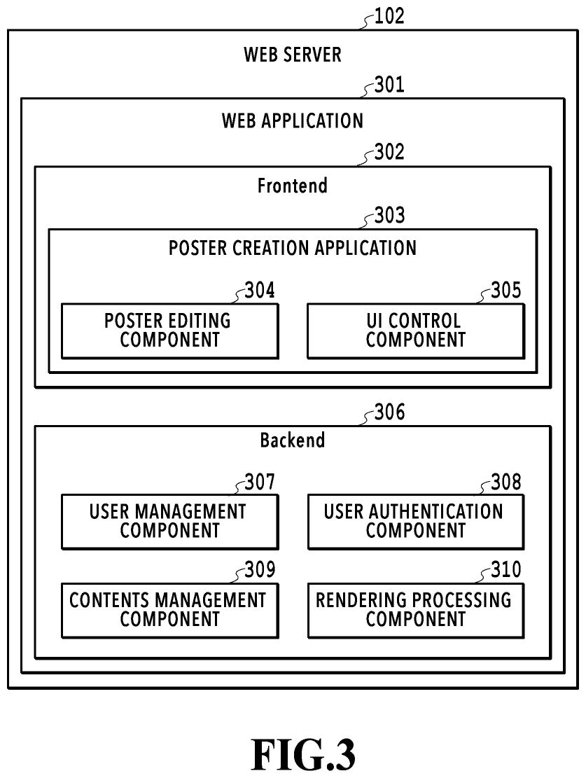

FIG. 3 is a diagram illustrating an example of the software configuration of the Web server 102. In the present embodiment, an explanation is given of the example in which the poster creation application 303 is implemented as the Web application 301. Note that the usage purposes of printed materials that are created with the poster creation application are not limited to posters, but include flyers, menus, calendars, photo collages, invitation cards, and various other printed materials. In the following explanation, these printed materials are also referred to as poster contents.

The Frontend 302 is a module that mainly controls the poster creation application 303. The poster creation application 303 includes the UI control component 305 and the poster editing component 304. The UI control component 305 performs the display control of the UI (user interface) screen displayed on the Web browser 402 of the terminal device 101, which is described later, and obtains data and user operations input from the terminal device 101 via the UI screen. The poster editing component 304 executes an editing process for the original document data of poster contents. In the editing process, original document data can be newly created, changed, deleted, etc.

The Backend 306 includes the user management component 307, the user authentication component 308, the contents management component 309, and the rendering processing component 310. The user management component 307 manages user information in association with user identification information that identifies a user. The user authentication component 308 issues the user identification information that uniquely identifies a user, and executes a user authentication process at the time of login. The contents management component 309 manages contents created by the application, templates used in the contents, objects included in the templates, and the like. For example, multiple templates for poster contents are assigned with template identification information that uniquely identifies each of them, so that the storing and retrieving of templates are managed according to instructions from the application. The rendering processing component 310 performs a rendering process for original document data.

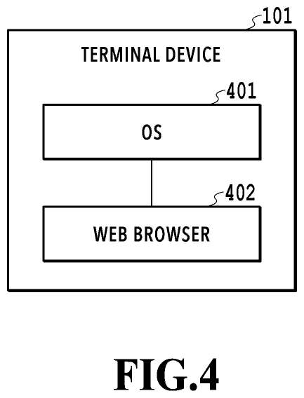

FIG. 4 is a diagram illustrating an example of the software configuration of the terminal device 101. The terminal device 101 can access the Web application 301 via the Web browser 402 that runs on the OS 401. On the UI screen of the poster creation application 303 displayed via the Web browser 402, the user performs editing operations on the original document data of poster contents. The created original document data is, for example, posted on a homepage, posted on an SNS, or printed by a printing apparatus connected to the terminal device 101. Further, although the poster creation application 303 is in the form of a Web application in the present embodiment, the poster creation application 303 may be stored in the storage device of the terminal device 101 and executed by the CPU of the terminal device 101.

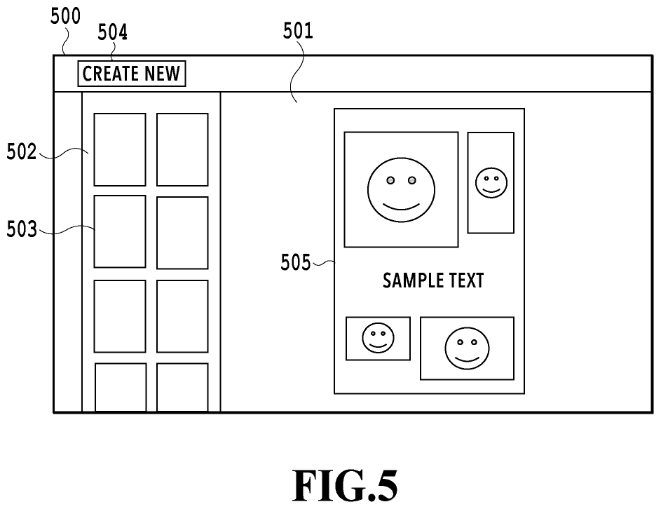

Next, an explanation is given of an example of the flow of a poster creation operation with the poster creation application 303. FIG. 5 shows an example of the conventional editing screen 500 of the poster creation application 303 displayed on the display unit 205 of the terminal device 101. The editing screen 500 includes, for example, the preview area 501, the template selection area 502, the templates 503, and the new creation button 504.

A preview of the original document data 505 of poster contents is displayed in the preview area 501, where the user checks and changes the layout of the poster in this area. The template selection area 502 displays the templates 503 which have different designs, respectively. If the user selects one of the templates 503, the selected template is applied to the full surface of the original document data in the preview area 501 and displayed. The original document data 505 can be selected from the templates, but the user can also press the new creation button 504 to create a poster with any desired design by adding any desired objects to blank original document data.

### <<Function of Applying Templates to Folding Areas>>

In the poster creation application 303 of the present embodiment, a template selected by the user can be applied to each folding area, which is an area that is created by folding a printed material. The poster creation application 303 has a function of resizing a template to match an area, to which the template is applied.

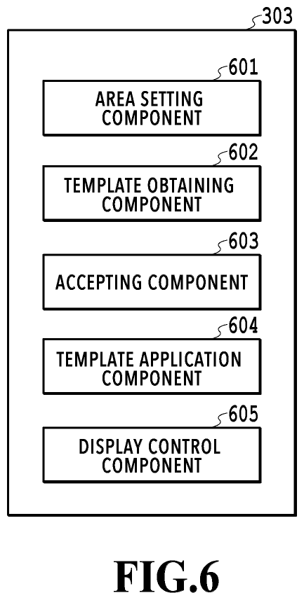

FIG. 6 is a block diagram for explaining the function of applying a template to a folding area, which is included in the poster creation application 303 of the present embodiment. As illustrated in FIG. 6, the poster creation application 303 includes the area setting component 601, the template obtaining component 602, the accepting component 603, the template application component 604, the display control component 605, and the like.

The area setting component 601 sets multiple areas to be formed on a printed material in the original document data of the printed material. In the present embodiment, the area setting component 601 sets, in the original document data, multiple areas to be formed by folding a printed material. In the following explanation, each of the multiple areas formed by folding a printed material is referred to as a folding area. The area setting component 601 sets, in the original document data of a printed material, multiple folding areas according to the type of folding selected by the user. The method for setting the folding areas is described later.

The template obtaining component 602 obtains the template data of poster contents. In the present embodiment, templates of poster contents are created for the entire original document data as one area. In a template, various objects such as a background object, a text object, a clip art object, a graphic object, and a photo object are laid out. The size, position, data, etc., of each object included in the templates can be changed. The template data includes information on the position and size of each object. It is assumed that the templates are stored, for example, in the storage device 206 of the Web server 102 or in an external storage server accessible by the Web server 102. Specific examples of a template for poster contents are described later.

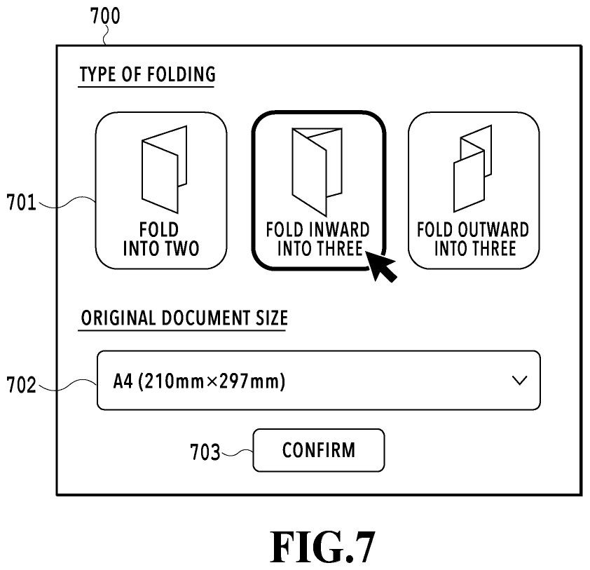

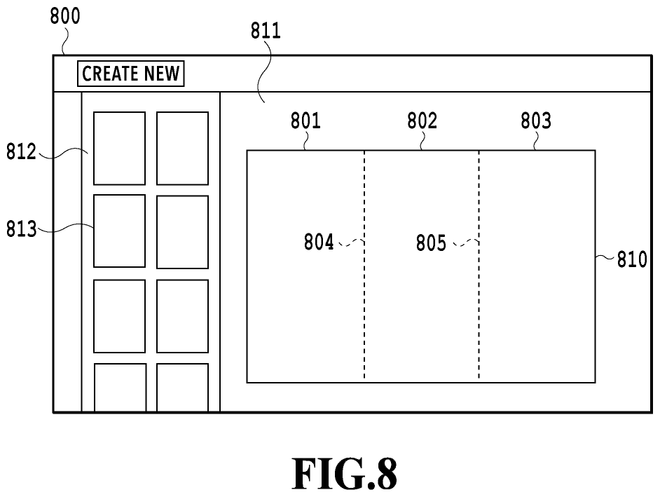

The accepting component 603 accepts a selection of a target folding area from among multiple folding areas set in the original document data of the printed material, and a selection of a template to be applied to the target folding area. Further, the accepting component 603 accepts a selection of the type of folding by the user. In a case where the accepting component 603 accepts a selection of the type of folding by the user, the area setting component 601 sets multiple folding areas in the original document data according to the type of folding accepted by the accepting component 603. The method for setting the folding areas is described later. Note that the accepting component 603 displays a first UI screen (FIG. 7) that accepts a selection of the type of folding for a printed material, and a second UI screen (FIG. 8) that displays the original document data in which multiple areas are set according to the selected type of folding and accepts editing operations on the original document data.

The template application component 604 obtains the data of a template selected by the accepting component 603, and applies the template to a selected target folding area. The template application component 604 resizes the template to match the size of the target folding area and applies the template. Further, it is preferable that the template application component 604 resizes the template so that the positional relationships between the multiple objects included in the template before resizing are maintained even after resizing. A detailed method for applying and resizing templates is described later.

The display control component 605 displays the editing screen 800 (the second UI screen) where the user edits the original document data, the printed material setup screen 700 (the first UI screen) where the user sets the type of folding and the size of the printed material, and the like. On the editing screen 800, the display control component 605 displays lines indicating the boundaries of the folding areas so that the lines are superimposed on the original document data. It is preferable that the lines indicating the boundaries are displayed in different display manners according to the shape of the printed material to be formed by folding the boundaries, such as a mountain fold or a valley fold. For example, it is preferable that the folds are displayed with different line types, such as a valley fold with a dotted line and a mountain fold with a chain line, or that the folds are displayed with different colors. Further, in a case where a target folding area and template are selected by the user on the editing screen 800 (the second UI screen), the display control component 605 displays the original document data with the selected template being applied to the target folding area.

FIG. 7 shows an example of the printed material setup screen 700 (the first UI screen). If the terminal device 101 accesses the poster creation application 303 via the Web browser 402, the printed material setup screen 700 is displayed on the display unit 205 of the terminal device 101. In the example shown in FIG. 7, the printed material setup screen 700 includes the folding type selection buttons 701, the original document size selection list 702, and the confirmation button 703.

The folding type selection buttons 701 are displayed for the respective types of folding that can be selected for the printed material. In a case where any of the buttons is selected by the user, the display control component 605 performs a toggle operation, so that only the type of folding selected by the user becomes a selected state.

The original document size selection list 702 displays a list of original document sizes for the printed material. In a case where the original document size selection list 702 is pressed by the user, the display control component 605 displays a list of selectable original document sizes. The user can select any desired original document size from the list.

The confirmation button 703 is operated to confirm the selection of the folding type and the selection of the original document size. If the confirmation button 703 is operated, the display control component 605 closes the printed material setup screen 700 and displays the editing screen 800.

FIG. 8 is a diagram illustrating an example of the editing screen 800 according to the present embodiment for creating a printed material that is intended to be folded for use. The editing screen 800 (the second UI screen) is displayed on the display unit 205 of the terminal device 101 if the confirmation button 703 is pressed with the type of folding being selected on the printed material setup screen 700. Note that FIG. 8 shows an example of a case of creating a printed material to be folded outward into three areas. In the preview area 811 of the editing screen 800, the original document data 810 is displayed. The poster templates 813 are displayed in the template selection area 812 of the editing screen 800.

In FIG. 8, the original document data 810 is displayed with the folding lines 804 and 805 corresponding to the outward folding into three areas, and the multiple folding areas 801, 802, and 803. The folding areas are the area to be formed if the printed material is folded.

The folding lines 804 and 805 are displayed in accordance with the type of folding selected by the user using the folding type selection buttons 701. The folding lines 804 and 805 each indicate the folding positions of the printed material, and are displayed at the boundary positions of the folding areas 801, 802, and 803, respectively.

The folding areas 801, 802, and 803 are areas surrounded by a contour indicating the outer edge of the original document data 810 and the folding lines 804 and 805, and are set according to the type of folding selected using the folding type selection buttons 701. The number of folding areas 801, 802, and 803 is set according to the selected type of folding. If the user selects any one of the multiple folding areas 801, 802, and 803, the CPU 201 sets the selected folding area in a selected state. If the user selects any of the templates 813 with any of the folding areas selected by the user, the CPU 201 (the template application component 604) applies the selected template 813 to the selected folding area. The application of templates is described later.

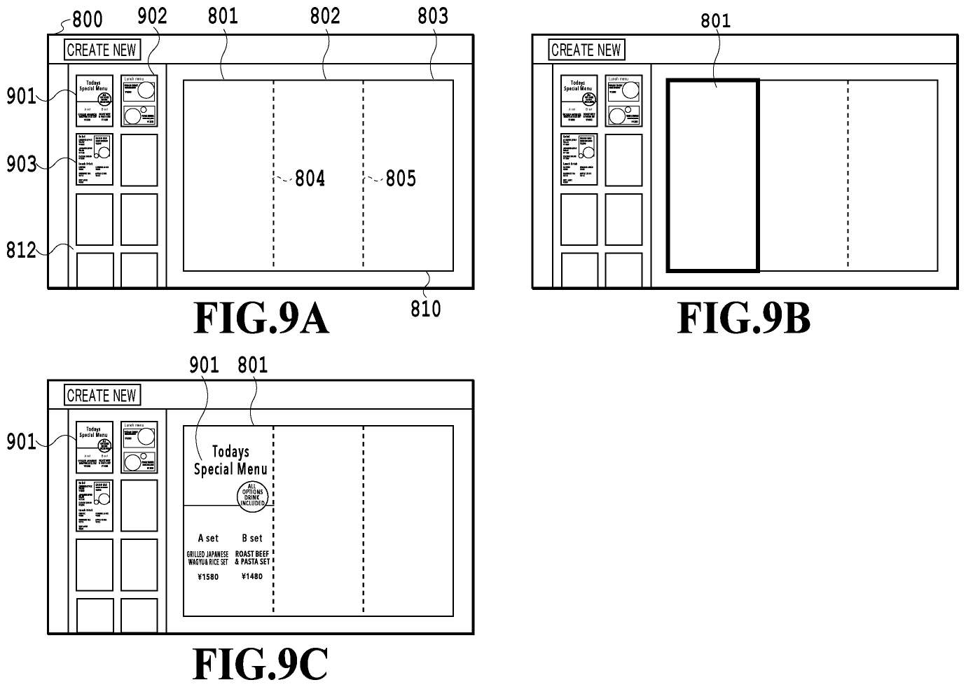

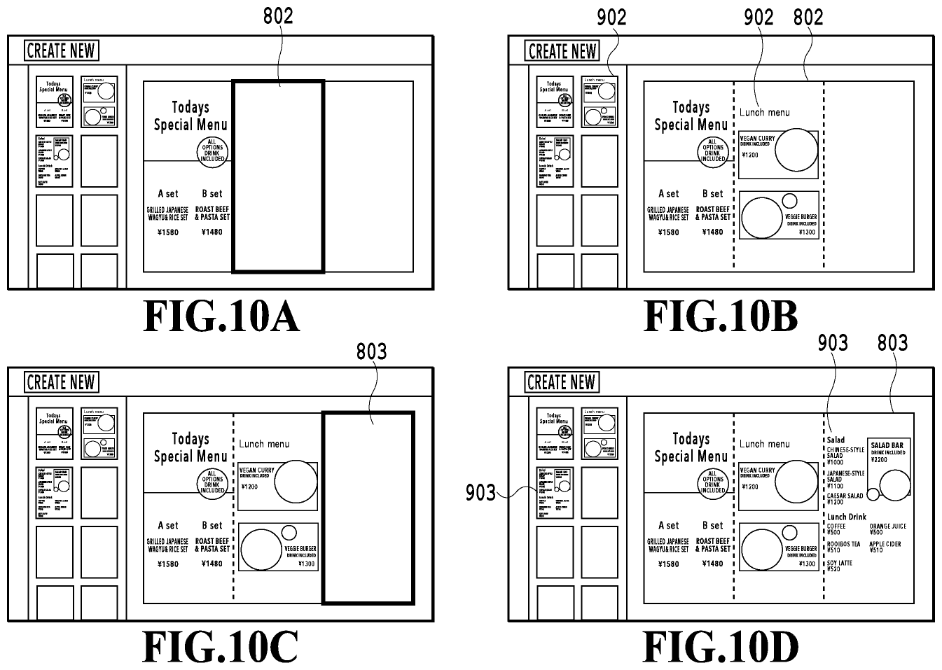

FIG. 9A to FIG. 9C and FIG. 10A to FIG. 10D are diagrams illustrating an operation procedure for applying templates to the folding areas 801, 802, and 803 in the present embodiment.

FIG. 9A shows the initial state of the editing screen 800 in a case of creating a printed material to be folded into three areas. On the editing screen 800 in its initial state, the multiple templates 901 to 903 are displayed in the template selection area 812. Further, in the original document data 810, which is the target of editing, the folding areas 801, 802, and 803 are set, and the folding lines 804 and 805 are displayed.

FIG. 9B shows a state in which the first given folding area is selected by the user. FIG. 9B shows, as an example, a state in which the left folding area 801 is selected. Further, the selected folding area 801 is indicated with a thick frame line. FIG. 9C shows a state in which the template selected by the user is applied to the selected folding area 801 by the template application component 604 of the poster creation application 303 from the state of FIG. 9B. FIG. 9C shows a state in which the selected template 901 is applied to the selected folding area 801.

FIG. 10A shows a state in which the second given folding area is selected by the user from the state of FIG. 9C. FIG. 10A shows a state in which the folding area 802 is selected. The selected folding area 802 is indicated with a thick frame line. FIG. 10B shows a state in which the template 902 selected by the user is applied to the selected folding area 802 by the template application component 604 of the poster creation application 303 from the state of FIG. 10A.

FIG. 10C shows a state in which the third given folding area 803 is selected by the user from the state of FIG. 10B. FIG. 10C shows a state in which the folding area 803 is selected. The selected folding area 803 is indicated with a thick frame line. FIG. 10D shows a state in which the template 903 selected by the user is applied to the selected folding area 803 by the template application component 604 of the poster creation application 303 from the state of FIG. 10C.

With the above-described procedure, at the time of creating original document data for a printed material that is intended to be folded for use, it is possible for the user to create a design by applying a poster template to each folding area set in the original document data. Note that, in the example of FIG. 9A to FIG. 9C and FIG. 10A to FIG. 10D, the templates 901 to 903 are each applied to the respective folding areas 801 to 803 in a single selection. In a case where the user wishes to redo it after checking the state in which a template is applied to a folding area, the user may select a folding area and template again and reapply the template.

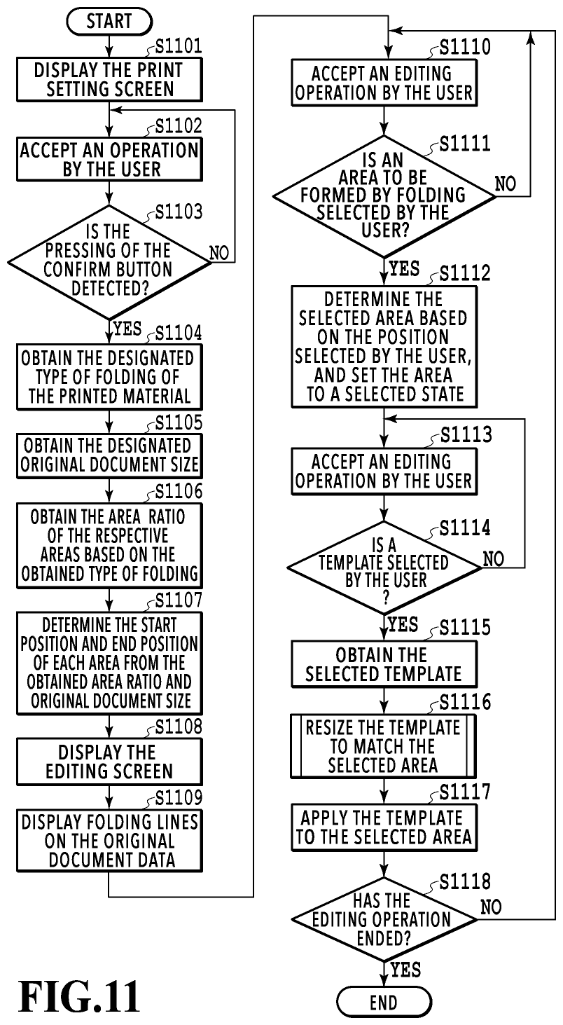

Next, with reference to the flowchart of FIG. 11, an explanation is given of a flow of the processing for applying a template to a folding area that is set in a printed material. FIG. 11 is a flowchart showing a flow of the template application processing executed by the poster creation application in the first embodiment. If the user of the terminal device 101 accesses the Web server 102 via the Web browser 402, first, a login process including user authentication is executed between the Web server 102 and the terminal device 101. After logging in, if the user of the terminal device 101 instructs the start of the poster creation application, the CPU 201 of the Web server 102 calls up and loads the program for the poster creation application stored in the storage device 206 into the RAM and executes the program. The program includes the processes shown in the flowchart of FIG. 11.

Note that, during execution of the poster creation application, the UI control component 305 (the CPU 201) of the Web server 102 causes a Web browser of the terminal device 101 to display various UI screens of the poster creation application. Further, the UI control component 305 obtains operation information input on the terminal device 101 side via the UI screens. The poster creation application executes the processes of FIG. 11 based on the operation information obtained by the UI control component 305. In the following explanation, it is assumed that the display information and operation information of the UI screens are transmitted and received according to the above-described procedure. Note that, in the following explanation, the symbol “S” represents a step.

In S1101, the CPU 201 displays the printed material setup screen 700 shown in FIG. 7. As described above, the printed material setup screen 700 is provided with the folding type selection buttons 701, the original document size selection list 702, and the confirmation button 703.

In S1102, the CPU 201 accepts an operation by the user. The CPU 201 accepts operations on the folding type selection buttons 701 and the original document size selection list 702 provided on the printed material setup screen 700.

In S1103, the CPU 201 detects that the confirmation button 703 is pressed by the user. If it is detected that the confirmation button 703 is pressed by the user, the processing proceeds to S1104, and if not detected, the processing proceeds to S1102.

In S1104, the CPU 201 obtains the type of folding of the printed material based on the information on the folding type selection button 701 selected by the user in S1102.

In S1105, the CPU 201 obtains the original document size of the printed material based on the information on the original document size selection list 702 selected by the user.

In S1106, the CPU 201 obtains the area ratio of the multiple folding areas set in the original document data, based on the type of folding of the printed material obtained in S1104. The area ratios are predefined for the respective types of folding and are stored in the storage device 206 of the Web server 102 or the like. Alternatively, the CPU 201 may obtain the area ratio of each folding area from an external Web server via the Internet 103 or the like.

In S1107, the CPU 201 calculates the start position and end position of each of the folding areas 801, 802, and 803 from the area ratio of the folding areas obtained in S1106 and the original document size obtained in S1105. Specifically, for example, assume that “FOLD OUTWARD INTO THREE” is selected as the type of folding for the printed material to be created, the area ratio of each folding area in “FOLD OUTWARD INTO THREE” is set to “1:1:1,” and the original document size is set to A4 (210×297 [mm]) landscape. In this case, since the heights of the respective folding areas 801, 802, and 803 in “FOLD OUTWARD INTO THREE” are equal, the area ratio is the ratio of the lengths of the base sides of the respective folding areas. Therefore, the length of the bottom side of each folding area is calculated by the following expression (1).

$$\frac{1}{3} \times 297 = 99 [ mm ] \qquad ( 1 )$$

Therefore, the range of each folding area can be expressed in a two-dimensional coordinate system where the bottom left corner of the original document data is the origin as follows: the range of the left folding area 801 is determined to be (0,0) to (99,210), the range of the central folding area 802 is determined to be (99,0) to (198,210), and the range of the right folding area 803 is determined to be (198,0) to (297,210).

In S1108, the CPU 201 displays the editing screen 800 as illustrated in FIG. 8. In S1109, the CPU 201 displays the folding lines 804 and 805 superimposed on the original document data 810 displayed in the preview area 811 of the editing screen 800. The folding lines 804 and 805 are displayed at the boundary positions of the respective folding areas 801, 802, and 803 determined in S1107. It is preferable that the folding lines 804 and 805 are displayed in a line type different from the line indicating the contour of the printed material. In the example of FIG. 8, the folding lines 804 and 805 are illustrated in dashed lines and the line indicating the contour is illustrated in a solid line.

In S1110, the CPU 201 accepts an input of an editing operation by the user for the original document data 810 displayed in the preview area 811. In S1111, the CPU 201 detects whether any one of the folding areas 801, 802, and 803 displayed in the preview area 811 is selected by the user with a mouse click operation or the like. If a selection by the user is detected, the processing proceeds to S1112, and if not, the processing returns to S1110.

In S1112, based on the position designated by the user detected in S1111 and the information on the start position and the end position of each of the folding area 801, 802, and 803 determined in S1107, the CPU 201 determines the folding area selected by the user, and sets the folding area to a selected state. In S1113, with any of the folding areas selected, the CPU 201 accepts an input of an editing operation by the user.

In S1114, the CPU 201 determines whether a user's selection operation to select any of the multiple the templates 813 displayed in the template selection area 812 is input. In a case where a user's selection operation is detected, the processing proceeds to S1115, and if not, the processing proceeds to S1113. Note that the multiple templates displayed in the template selection area 812 are templates designed for creating poster contents as a flat surface without folding the printed material.

In S1115, the CPU 201 obtains information of the template 813 selected by the user. The information of the template 813 is predefined for each type of template, and is stored in the storage device 206 of the Web server 102 or the like. Alternatively, the CPU 201 may obtain the information of the template 813 selected by the user from an external Web server via the Internet 103 or the like.

In S1116, the CPU 201 resizes the template 813 obtained in S1115 to match the size of the folding area selected in S1112. The contents of the resizing process are described in detail later. In S1117, the CPU 201 applies the template 813 resized in S1116 to the folding area selected in S1112.

In S1118, the CPU 201 determines whether the user's editing operation has ended. In a case where it is determined that the editing operation has not ended, the processing proceeds to S1110. In a case where it is determined that the editing operation has ended, the processing shown in the present flowchart ends.

### <<Template Resizing Process>>

An explanation is herein given of the template resizing process in S1116 for changing the size of a template and changing the size and position of each object included in the template.

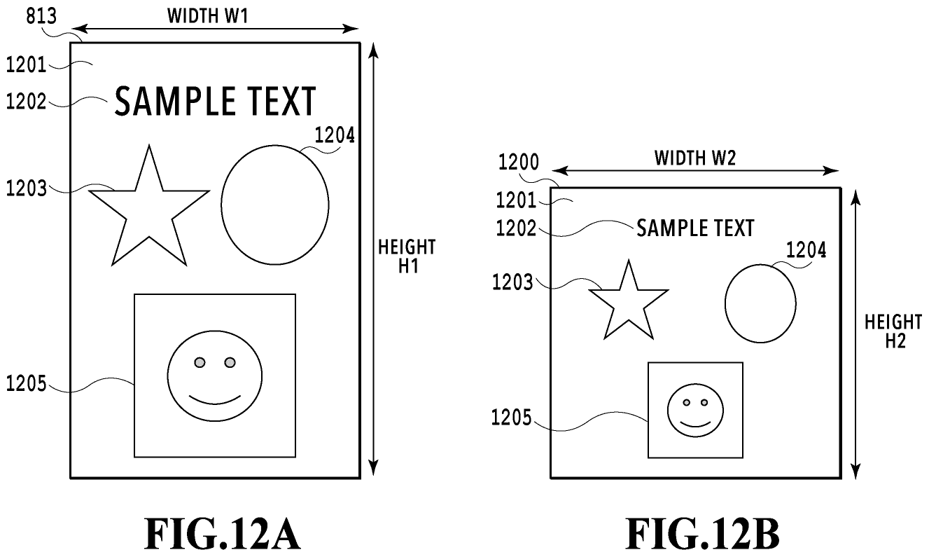

FIG. 12A and FIG. 12B are diagrams for explaining the resizing of a template. FIG. 12A shows the template 813 before resizing, and FIG. 12B shows the template 1200 after resizing. The templates 813 and 1200 may include the background object 1201, the text object 1202, the clip art object 1203, the graphic object 1204, and the photo object 1205. Further, the templates 813 and 1200 include size information. In the following explanation, it is assumed that the width and height of the template 813 before resizing in FIG. 12A are W1 and H1, respectively, and the width and height of the template 1200 after resizing in FIG. 12B are W2 and H2, respectively.

The background object 1201 has information of its position, size, and object type pertaining to the original document data. The size of the background object 1201 is the same as the original document size of the template. The background object is displayed so that its reference position always matches the reference position of the original document data. Hereinafter, it is assumed that the center of the background object is the reference position.

Each of the text object 1202, the clip art object 1203, the graphic object 1204, and the photo object 1205 has information of its position, size, and object type, and the positions and sizes can be changed in any desired manner. Note that the reference positions of the text object 1202, the clip art object 1203, the graphic object 1204, and the photo object 1205 are the center positions of the respective objects.

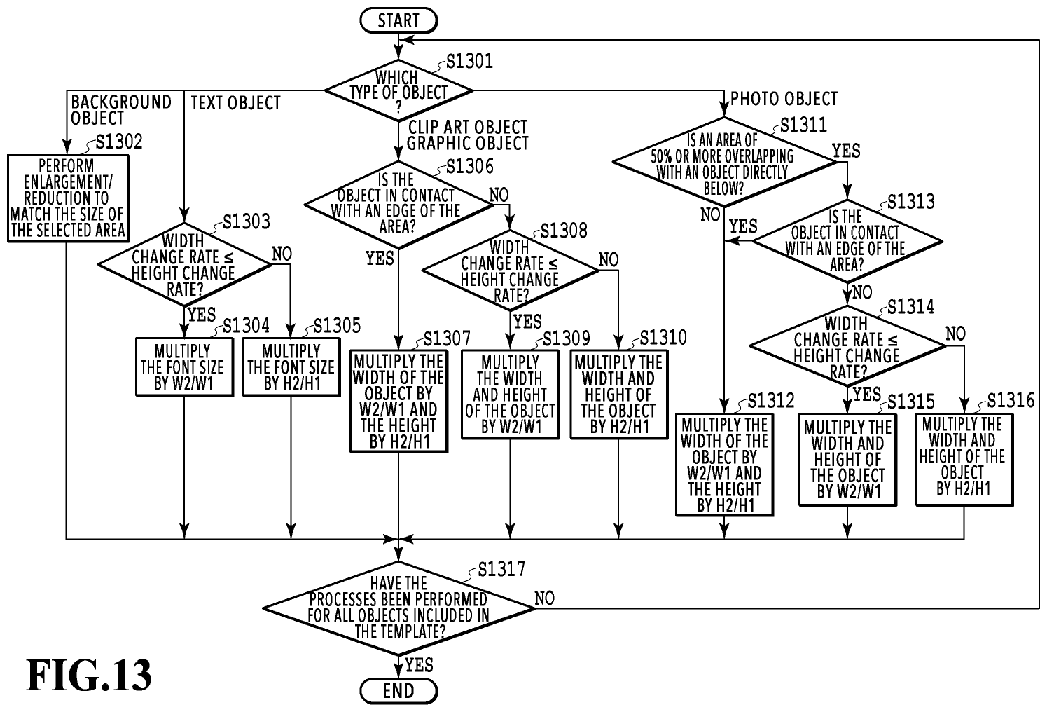

Next, with reference to the flowchart of FIG. 13, an explanation is given of the processing for changing the size of each object included in the template 813. According to the processing of the flowchart shown in FIG. 13, the size of each object is changed so that the object is included within a range inscribed in the resized template size. Further, the clip art object 1203, the graphic object 1204, and the photo object 1205 are often used as backgrounds, and thus the resizing is performed to avoid losing the design even in such cases. The processing shown in FIG. 13 is included in the poster creation application 303, and the processing starts in S1116 of FIG. 11.

In S1301, the CPU 201 determines the type of the object to be the target of the processing (hereinafter referred to as the target object).

In S1301, in a case where it is determined that the type of the target object is the background object 1201, the processing proceeds to S1302. In S1302, the CPU 201 enlarges or reduces the size (W1, H1) of the background object 1201 to match the size (W2, H2) of the selected folding area. If it is determined in S1301 that the type of the target object is the text object 1202, the processing proceeds to S1303.

In S1303, the CPU 201 determines if the width change rate (W2/W1) is equal to or less than the height change rate (H2/H1). In a case where it is determined in S1303 that the width change rate is equal to or less than the height change rate, the processing proceeds to S1304. In S1304, the CPU 201 multiplies the font size of the text object 1202 by W2/W1.

In a case where it is determined in S1303 that the width change rate is greater than the height change rate, the processing proceeds to S1305. In S1305, the CPU 201 multiplies the font size of the text object 1202 by H2/H1.

In S1301, in a case where it is determined that the type of the target object is the clip art object 1203 or the graphic object 1204, the processing proceeds to S1306. In S1306, the CPU 201 determines whether the clip art object 1203 or the graphic object 1204 is in contact with an edge of the selected folding area.

In a case where it is determined in S1306 that the clip art object 1203 or the graphic object 1204 is in contact with an edge of the selected folding area, the processing proceeds to S1307. In S1307, the CPU 201 multiplies the width of the clip art object 1203 or the graphic object 1204 by W2/W1 and the height by H2/H1.

In a case where it is determined in S1306 that the clip art object 1203 or the graphic object 1204 is not in contact with an edge of the folding area, the processing proceeds to S1308. In S1308, the CPU 201 determines if the width change rate is equal to or less than the height change rate.

In S1308, in a case where the width change rate is equal to or less than the height change rate, the processing proceeds to S1309. In S1309, the CPU 201 multiplies the width and height of the clip art object 1203 or the graphic object 1204 by W2/W1.

In a case where it is determined in S1308 that the width change rate is greater than the height change rate, the processing proceeds to S1310. In S1310, the CPU 201 multiplies the width and height of the clip art object 1203 or the graphic object 1204 by H2/H1.

In a case where it is determined in S1301 that the type of the target object is the photo object 1205, the processing proceeds to S1311. In S1311, the CPU 201 determines if an area of 50% or more of the size of the photo object 1205 is overlapping with an object directly below. The herein-mentioned object directly below refers to an object that is located vertically below the plane representing the original document data. If the front side from the user's perspective is considered as the foreground (top), then the object on the background side of the photo object 1205 is the object directly below. Note that, although the threshold value for determining the overlap amount of objects is described as 50%, there is no such limitation to this value, and other values are also possible. In this example, 50% is adopted as a suitable threshold value based on experience.

In S1311, in a case where it is determined that an area of 50% or more of the size of the photo object 1205 is not overlapping with an object directly below, the processing proceeds to S1312. In S1312, the CPU 201 multiplies the width of the photo object 1205 by W2/W1 and the height by H2/H1. In S1311, in a case where it is determined that an area of 50% or more of the size of the photo object 1205 is overlapping with an object directly below, the processing proceeds to S1313.

Since S1313 to S1316 are the same processes as S1306 to S1310, the explanations thereof are omitted here.

In S1317, the CPU 201 determines whether the processes of S1301 to S1316 have been performed for all objects included in the template 813 (1200). In a case where it is determined that there is an object that has not been processed, the processing proceeds to S1301. In a case where it is determined that the processes of S1301 to S1316 have been performed for all objects, the present flowchart ends.

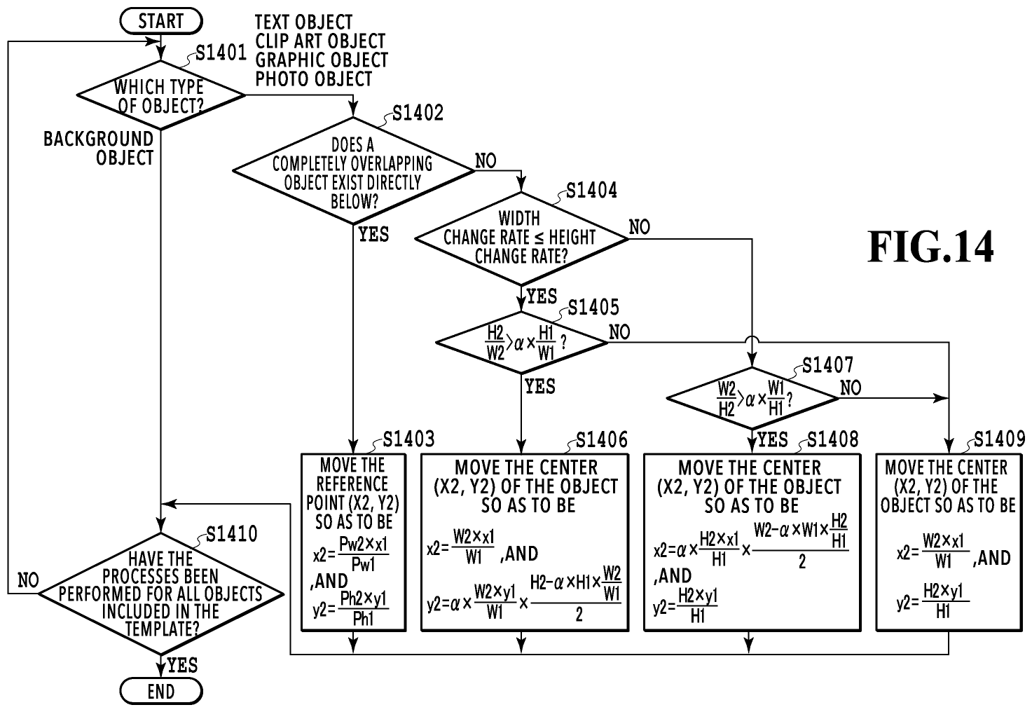

Next, with reference to the flowchart in FIG. 14, an explanation is given of the processing for changing the position of each object included in the template 813. According to the processing of the flowchart shown in FIG. 14, the position of each object is changed so that the object is included within a range inscribed in the resized template size. Further, the position of each object is changed while maintaining the positional relationships with the object used as the foreground and with the object used as the background. Furthermore, even in a case where resizing is performed with an extremely different aspect ratio, a positional change with prevention from losing the design will be performed. The processing shown in the present flowchart is included in the poster creation application 303, and the processing starts after the processing shown in FIG. 13 ends. However, the determination for the overlap of objects in S1402 is performed based on the state before the processing of FIG. 13 is executed (the state before the objects are enlarged or reduced).

In S1401, the CPU 201 determines the type of the target object. In a case where it is determined in S1401 that the target object is the background object 1201, the CPU 201 proceeds the processing to S1410 without changing the position of the background object 1201.

In a case where it is determined in S1401 that the target object is any one of the text object 1202, the clip art object 1203, the graphic object 1204, and the photo object 1205, the processing proceeds to S1402. In S1402, the CPU 201 determines whether another object completely overlapping with the target object exists directly below the target object.

In a case where it is determined in S1402 that another object completely overlapping with the target object exists directly below the target object, the processing proceeds to S1403. In S1403, the CPU 201 calculates the coordinates (x2, y2), which indicates the changed reference position of the target object, using the following expressions (2) and (3). Note that the reference position of an object is the center position of the object.

$$x 2 = \frac{P w 2 \times x 1}{P w 1} \qquad ( 2 )$$

$$y 2 = \frac{P h 2 \times y 1}{P h 1} \qquad ( 3 )$$

Note that (x1, y1) is the reference position of the target object before resizing, (Pw1, Ph1) is the width and height of another object overlapping with the target object before resizing, and (Pw2, Ph2) is the width and height of another object overlapping with the target object after resizing.

In a case where it is determined in S1402 that no other objects completely overlapping with the target object exist directly below the target object, the processing proceeds to S1404. In S1404, the CPU 201 determines if the width change rate (W2/W1) of the template is equal to or less than the height change rate (H2/H1). The change rates of the width and height of the template are the enlargement/reduction rates used in S1302 of FIG. 13.

In S1404, in a case where the width change rate (W2/W1) of the template is equal to or less than the height change rate (H2/H1), the processing proceeds to S1405. In S1405, the CPU 201 determines whether the following expression (4) is satisfied. Note that, in the expression (4), a is a positive numerical value, and is preferably set to, for example, “1.5” based on experience. However, a is not limited to 1.5, and may be any desired value.

$$\frac{H 2}{W 2} > α \times \frac{H 1}{W 1} \qquad ( 4 )$$

In a case where it is determined in S1405 that the condition of the expression (4) is satisfied, the processing proceeds to S1406. In S1406, the CPU 201 calculates the center coordinates (x2, y2) of the target object, using the following expressions (5) and (6).

$$x 2 = \frac{W 2 \times x 1}{W 1} \qquad ( 5 )$$

$$y 2 = α \times \frac{W 2 \times y 1}{W 1} \times \frac{H 2 - α \times H 1 \times \frac{W 2}{W 1}}{2} \qquad ( 6 )$$

In S1404, in a case where the width change rate (W2/W1) of the template is greater than the height change rate (H2/H1), the processing proceeds to S1407. In S1407, whether the following expression (7) is satisfied is determined.

$$\frac{W 2}{H 2} > α \times \frac{W 1}{H 1} \qquad ( 7 )$$

In a case where it is determined in S1407 that the condition is satisfied, the processing proceeds to S1408. In S1408, the CPU 201 calculates the center coordinates (x2, y2) of the target object, using the following expressions (8) and (9).

$$x 2 = α \times \frac{H 2 \times x 1}{H 1} + \frac{W 2 - α \times W 1 \times \frac{H 2}{H 1}}{2} \qquad ( 8 )$$

$$y 2 = \frac{H 2 \times y 1}{H 1} \qquad ( 9 )$$

In a case where it is determined in S1405 that the condition of the expression (4) is not satisfied, or in a case where it is determined in S1407 that the condition of the expression (7) is not satisfied, the processing proceeds to S1409. In S1409, the CPU 201 calculates the center coordinates (x2, y2) of the target object, using the following expressions (10) and (11).

$$x 2 = \frac{W 2 \times x 1}{W 1} \qquad ( 10 )$$

$$y 2 = \frac{H 2 \times y 1}{H 1} \qquad ( 11 )$$

In S1410, the CPU 201 determines whether the processes of S1401 to S1409 have been performed for all objects included in the template. In a case where it is determined that there is an object that has not been processed, the processing proceeds to S1401, and in a case where it is determined that all objects have been processed, the processing of the present flowchart ends.

By carrying out the above-described processing, it becomes possible to rearrange each object in consideration of the positional relationships of the respective objects defined in the template. Note that the method of resizing the template is not limited to the above-described method shown in FIG. 13 and FIG. 14, and any other method may be used.

As explained above, according to the present embodiment, areas corresponding to multiple folding areas to be formed in a printed material are set in the original document data of the printed material, and template data is obtained in response to a user's selection operation and the template is applied to an area selected by the user. Therefore, it becomes possible to apply a template to each of the multiple areas to be formed on a printed material. This allows the user to create highly sophisticated designs for the respective folding areas with a minimal amount of work, based on templates for poster contents. Note that, in the explanation of the above-described embodiment, the case where the areas to be formed on the printed material are formed by folding the printed material is taken as an example, but the present disclosure is not limited as such. For example, the present disclosure can be applied to a case where the areas are formed on a printed material by a method other than folding, such as a cut line.

### Second Embodiment

At the time of creating original document data for a printed material in which multiple areas are formed in the first embodiment, the user may be allowed to select whether to edit each of the multiple areas or to edit the entire original document data as one area regardless of the areas.

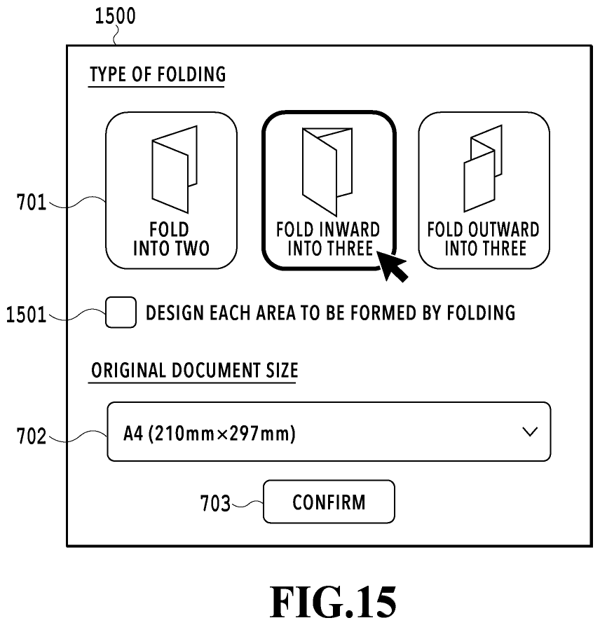

FIG. 15 is a diagram illustrating an example of the printed material setup screen 1500 for a printed material according to the second embodiment. The printed material setup screen 1500 in the second embodiment is provided with an operation part for switching to the processing of “DESIGN EACH AREA TO BE FORMED BY FOLDING.” The printed material setup screen 1500 includes the folding type selection buttons 701, the original document size selection list 702, and the confirmation button 703, as with the printed material setup screen 700 of the first embodiment illustrated in FIG. 7. Further, the printed material setup screen 1500 also has an operation part (hereinafter, the switching button 1501) that is operated by the user to switch between whether or not to design each folding area.

The switching button 1501 is switched between on and off each time it is operated. In a case where the confirmation button 703 is operated with the switching button 1501 in the on state, the CPU 201 performs the operation (the second mode) described in the first embodiment. That is, the folding areas corresponding to the type of folding selected using the folding type selection buttons 701 are set in the original document data, so that the user can apply a selected template to each folding area. On the other hand, in a case where a folding type is selected using the folding type selection buttons 701 and the confirmation button 703 is operated with the switching button 1501 in the off state, the CPU 201 operates in the first mode. That is, the entire original document data becomes editable as one area. That is, although the folding areas are set in the original document data, it is possible to arrange a poster template over the entire original document data without depending on the folding areas.

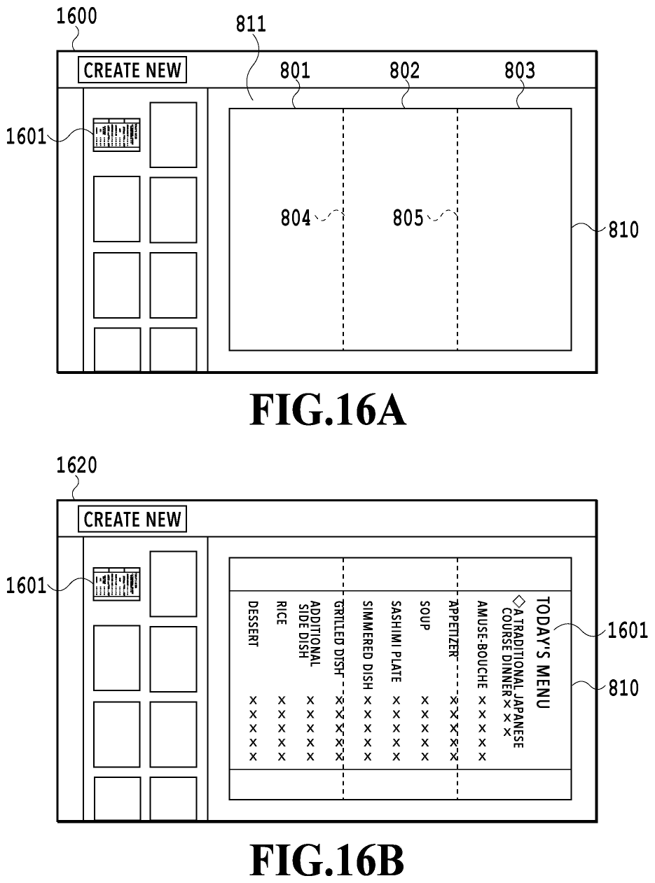

FIG. 16A and FIG. 16B are diagrams illustrating an operation procedure in a case where the full surface of the original document data of a printed material that is intended to be folded for use is treated as one area. As an example, the editing screen 1600 in a case where the inward folding into three areas is selected and the confirmation button 703 is operated with the switching button 1501 in the off state is illustrated.

As illustrated in FIG. 16A, the original document data 810 is displayed in the preview area 811 of the editing screen 1600, as with the editing screen 1600 of FIG. 8 in the first embodiment. In the original document data 810, the folding lines 804 and 805 are superimposed and displayed, but because the switching button 1501 is in the off state, each of the folding areas 801, 802, and 803 cannot be selected.

If the user selects the given template 1601 in the state of FIG. 16A, the screen transitions to the state of FIG. 16B. In FIG. 16B, the editing screen 1620 in which the template 1601 is selected is illustrated as an example. In FIG. 16B, the template 1601 is applied to the entire original document data 810.

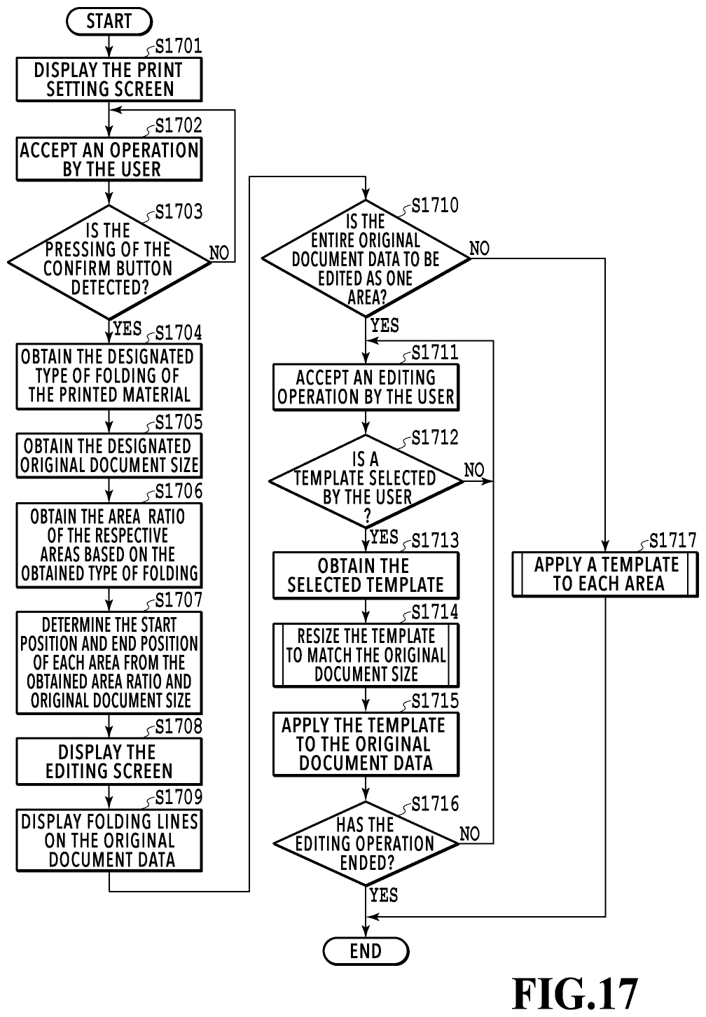

Next, with reference to the flowchart of FIG. 17, an explanation is given of the operation of the second embodiment. FIG. 17 is a flowchart in which whether to edit each folding area or to edit the entire original document data as one area can be selected at the time of creating a printed material. The present flowchart is the processing included in the poster creation application 303, and the CPU 201 starts the processing at the time of displaying the printed material setup screen 1500 on the display unit 205 of the terminal device 101.

The processes of S1701 to S1709 are the same as those of S1101 to S1109 in the flowchart shown in FIG. 11, and thus the explanations thereof are omitted.

In S1710, the CPU 201 determines whether the editing of the entire original document data as one area is selected. That is, whether the switching button 1501 is in the off state is determined. In a case where it is determined in S1710 that the switching button 1501 is in the off state, the processing proceeds to S1711.

In S1711, the CPU 201 accepts an editing operation by the user on the original document data 810 displayed in the preview area 811.

In S1712, the CPU 201 detects whether any of the templates 1601 is selected by the user from the template selection area. If detected, the processing proceeds to S1713, and if not detected, the processing proceeds to S1711.

In S1713, the CPU 201 obtains information on the template 1601 selected by the user.

In S1714, the CPU 201 resizes the template 1601 obtained in S1713 to match the original document size. The resizing process may be performed in the same method as the resizing process shown in the first embodiment (FIG. 13 and FIG. 14).

In S1715, the CPU 201 applies the template resized in S1714 to the original document data 810.

In S1716, the CPU 201 determines whether the user's editing operation has ended. In a case where it is determined that the editing operation has not ended, the processing proceeds to S1711. In a case where it is determined that the editing operation has ended, the processing ends.

In a case where it is determined in S1710 that the switching button 1501 is in the on state, where the editing of the entire original document data as one area is not selected, the processing proceeds to S1717.

In S1717, the CPU 201 performs the same processes as in S1110 to S1118 of FIG. 11. Since the contents of the processing overlap with those described in the first embodiment, the explanations thereof are omitted.

According to the second embodiment, at the time of creating original document data for a printed material in which multiple areas are formed, it is possible to switch by a user's operation whether to edit the entire original document data as one area or to edit it for each folding area, depending on the usage purpose. This allows the user to create printed materials for a variety of usage purposes.

### Third Embodiment

In the processing shown in the first embodiment, information regarding a connection of multiple areas formed on a printed material may be further predefined, so that multiple areas can be selected as one area based on that information.

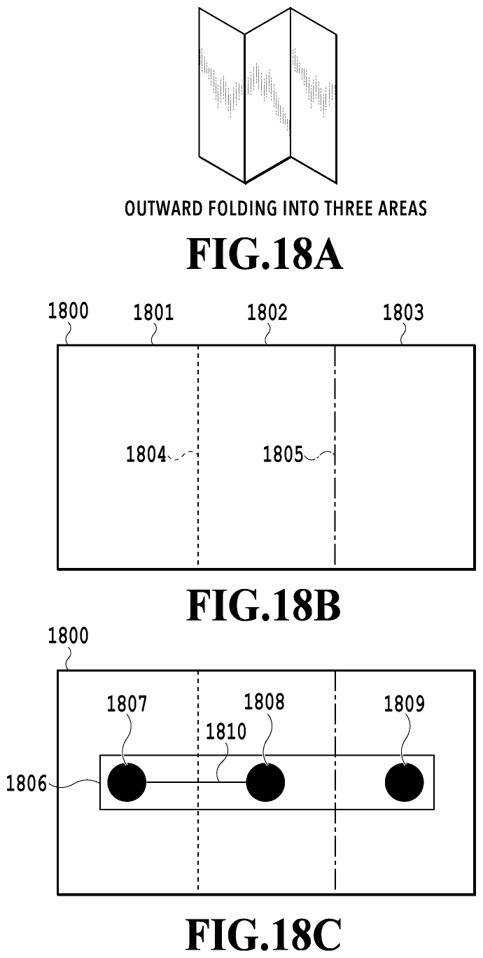

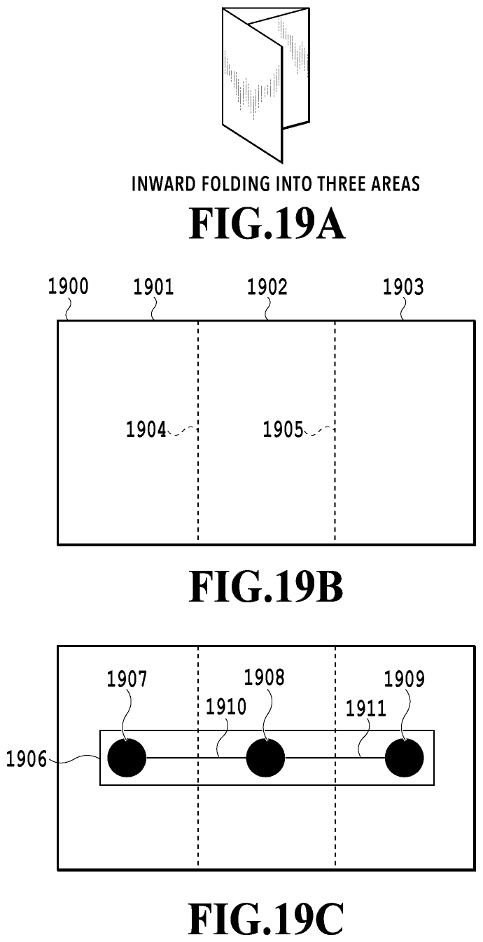

First, with reference to FIG. 18A to FIG. 18C and FIG. 19A to FIG. 19C, an explanation is given of the relationships among multiple areas formed on a printed material. FIG. 18A is a diagram showing a type of folding, and an example of the outward folding into three areas is illustrated. FIG. 18B is a plan view showing the state in which the printed material folded outward into three areas illustrated in FIG. 18A is unfolded. In the plan view, the contour 1800 of the printed material, the left folding area 1801, the central folding area 1802, the right folding area 1803, the valley folding line 1804, and the mountain folding line 1805 are illustrated.

Both the valley folding line 1804 and the mountain folding line 1805 are lines that indicate a folding position, but in FIG. 18B, in order to illustrate a three-dimensional fold on a two-dimensional plane, the valley folding line 1804 is illustrated as a dashed line and the mountain folding line 1805 is illustrated as a chain line.

FIG. 18C is a diagram in which the relationship graph 1806 indicating the relationships of the folding areas is superimposed and displayed on the plan view of FIG. 18B. The relationship graph 1806 is a graph showing the information regarding a connection of multiple areas formed on a printed material, and includes the nodes 1807 to 1809 and the edge 1810. In the relationship graph 1806 illustrated in the present embodiment, one node is provided for each folding area. That is, the left node 1807 corresponds to the left folding area 1801, the central node 1808 corresponds to the central folding area 1802, and the right node 1809 corresponds to the right folding area 1803, respectively. In a case where folding areas can be connected and treated as one area, the edge 1810 is defined, so as to connect the nodes corresponding to those areas. Although the left folding area 1801 and the central folding area 1802 are separated by the valley folding line 1804 in FIG. 18B, the left folding area 1801 and the central folding area 1802 may be treated as one area in such a way as a double-page spread. In this case, the edge 1810 that connects the left node 1807 and the central node 1808 is defined. In this way, the information regarding a connection of multiple areas is defined in the relationship graph. Further, it is preferable that the information regarding a connection of multiple areas is determined based on the positional relationship of the multiple areas at the time the printed material is in the folded state.

FIG. 19A to FIG. 19C are diagrams for explaining another example of the relationships among multiple areas formed on a printed material. FIG. 19A shows that the type of folding is the inward folding into three areas. FIG. 19B is a plan view of the state in which the printed material folded inward into three areas illustrated in FIG. 19A is unfolded. In the plan view, the contour 1900 of the printed material, the left folding area 1901, the central folding area 1902, the right folding area 1903, and the valley folding lines 1904 and 1905 are illustrated.

FIG. 19C is a diagram in which the relationship graph 1906, where the information regarding a connection of multiple areas is defined, is superimposed and displayed on the plan view of FIG. 19B. The relationship graph 1906 includes the nodes 1907 to 1909 and the edges 1910 and 1911. In the relationship graph 1906, a node is provided for each folding area. That is, the left node 1907 corresponds to the left folding area 1901, the central node 1908 corresponds to the central folding area 1902, and the right node 1909 corresponds to the right folding area 1903, respectively. In a case where folding areas can be connected and treated as one area, the edges 1910 and 1911 are defined, so as to connect the nodes corresponding to those areas. In the case of FIG. 19C, the left folding area 1901 and the central folding area 1902 may be treated as one area in such a way as a double-page spread. Similarly, the central folding area 1902 and the right folding area 1903 may be treated as one area in such a way as a double-page spread. In this case, the edge 1910 is defined to connect the left node 1907 and the central node 1908, and the edge 1911 is defined to connect the central node 1908 and the right node 1909. Note that the processing in a case where the entire printed material is treated as one page (one area) is shown in the second embodiment.

For other types of folding besides the outward folding into three areas and the inward folding into three areas, relationship graphs indicating the information regarding a connection of multiple areas are predefined and stored in the storage device 206. Alternatively, a configuration in which information indicating the relationships of folding areas (the relationship graph) is stored in an external Web server and obtained from the external Web server is also possible. Note that, since valley folds and mountain folds are reversed between the front surface and back surface of a printed material, relationship graphs may be defined for the front surface and the back surface, respectively, for each type of folding. Further, although a description is given of the example in which the information regarding a connection of multiple areas is expressed in the form of a such graph as the relationship graph, it is not limited to the form of a graph, and the information regarding a connection of multiple areas may be defined in the form of a data table or other forms.

Next, an explanation is given about a user operation in a case where multiple folding areas are connected and treated as one folding area. In the third embodiment, in a case where a user performs a specific operation (the second operation) different from the operation of selecting one area (the first operation), the CPU 201 accepts the selection, assuming that at least two areas out of the multiple areas set in the original document data are one connected area. The first operation in the present embodiment is an operation of designating a position outside a valid specific operation range on the original document data. The second operation is an operation of designating a position within a valid specific operation range on the original document data. Note that the specific operation is not limited to this example, and may be another operation, such as a simultaneous operation of selecting a specific key on a keyboard and selecting an area, or in a case of a touch panel, an operation of touching multiple areas simultaneously with multiple fingers.

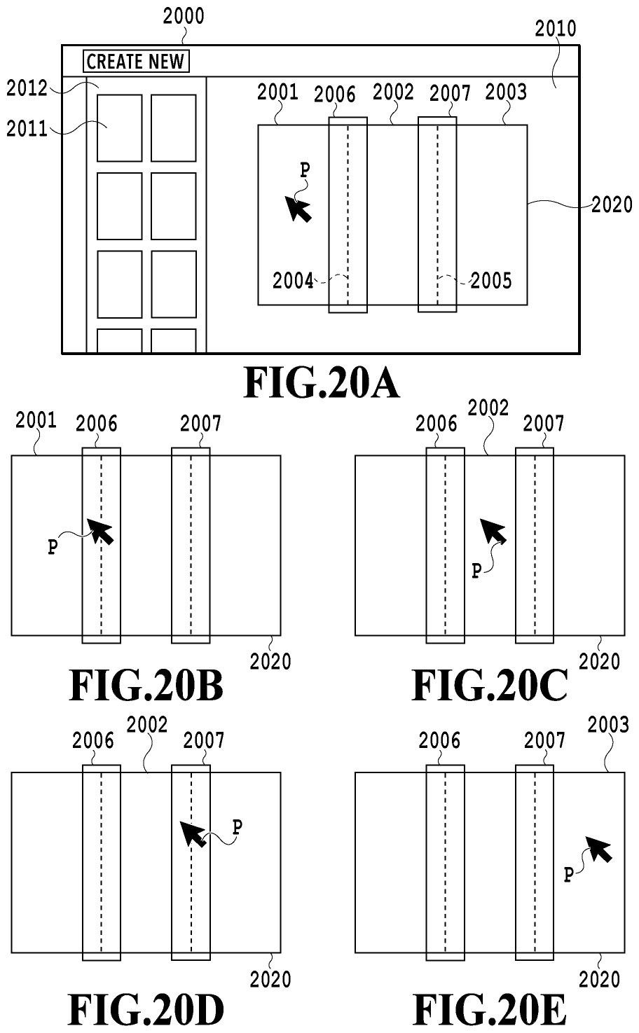

FIG. 20A to FIG. 20E are diagrams illustrating an operation procedure for a user to select multiple folding areas as one area based on predefined information regarding a connection of multiple areas (hereinafter referred to as a relationship graph). Note that FIG. 20A to FIG. 20E show an example of the operational procedure in a case of creating a printed material to be folded outward into three areas. The relationship graph for the outward folding into three areas is assumed to be the relationship graph 1806 illustrated in FIG. 18C. FIG. 20A shows an example of the editing screen 2000 of the third embodiment. The editing screen 2000 is provided with the template selection area 2012 and the preview area 2010, as with the editing screens illustrated in the first and second embodiments. The selectable templates 2011 are displayed in the template selection area 2012, and the original document data 2020 of the printed material is displayed in the preview area 2010. In the original document data 2020 displayed in the preview area 2010, the folding lines 2004 and 2005 are displayed, and the folding areas 2001, 2002, and 2003 are set.

In the preview area 2010, the pointer P which indicates the position designated by the user is displayed. Furthermore, the specific operation ranges 2006 and 2007 are set above the folding lines 2004 and 2005 of the original document data 2020, respectively. In the example of FIG. 20A to FIG. 20E, the left specific operation range 2006 is set above the left folding line 2004, and the right specific operation range 2007 is set above the right folding line 2005. The specific operation ranges 2006 and 2007 each have an area, and, with the position of each folding line as the center, the range enclosing a predetermined distance from the folding line is set as each of the specific operation ranges 2006 and 2007.

The pointer P indicates the position designated by the user, and is movable via the input interface 207. Note that, in a case of using an input device that allows the user to directly point to the screen, such as a touch panel, the pointer P does not need to be displayed.

The left specific operation range 2006 and the right specific operation range 2007 are defined as valid or invalid depending on the presence or absence of the edge 1810 defined in the relationship graph 1806 of the outward folding into three areas illustrated in FIG. 18C. Specifically, in the case of the relationship graph 1806 of the outward folding into three areas, the edge 1810 exists between the left node 1807 and the central node 1808, and thus the left specific operation range 2006 is set as valid. The right specific operation range 2007 is set as invalid because no edge exists between the central node 1808 and the right node 1809. Although the left specific operation range 2006 and the right specific operation range 2007 are illustrated for the sake of explanation, a form in which they are invisible to the user is also possible.

FIG. 20B to FIG. 20E each show the original document data 2020 in the preview area 2010 of the editing screen 2000. FIG. 20A, FIG. 20C, and FIG. 20E each show a state in which the pointer P is located on the left folding area 2001, the central folding area 2002, or the right folding area 2003. In the state of FIG. 20A, the CPU 201 determines that the left folding area 2001 is designated by the user. Similarly, it is determined that the central folding area 2002 is designated by the user in the state of FIG. 20C, and the right folding area 2003 is designated by the user in the state of FIG. 20E.

FIG. 20B shows a state in which the pointer P is within the left specific operation range 2006. In this case, the CPU 201 first determines the left folding area 2001 indicated by the pointer P as the first selected area. Next, the CPU 201 determines whether the left specific operation range 2006 is valid. As described above, the left specific operation range 2006 is defined as valid based on the relationship graph 1806. In a case where the specific operation range is valid, the CPU 201 obtains the left node 1807 corresponding to the first selected area and the central node 1808 connected to the left node 1807. Then, the CPU 201 determines the central folding area 2002 corresponding to the central node 1808 as the second selected area. Finally, the CPU 201 determines the area formed by connecting the first selected area and the second selected area as the third selected area. In this way, the third area is determined by the validity/invalidity of the specific operation range and the position of the pointer P. If the user performs a confirm operation in this state, the CPU 201 confirms the third selected area as the area selected by the user.

FIG. 20D shows a state in which the pointer P is within the right specific operation range 2007. In this case, the CPU 201 first determines the central folding area 2002 where the pointer P is located as the first selected area. Next, whether the right specific operation range 2007 is valid is determined. As described above, the right specific operation range 2007 is defined as invalid based on the relationship graph 1806. In a case where the specific operation range is invalid, the CPU 201 determines the first selected area as the third selected area. If the user performs a confirm operation in this state, the CPU 201 confirms the third selected area as the area selected by the user.

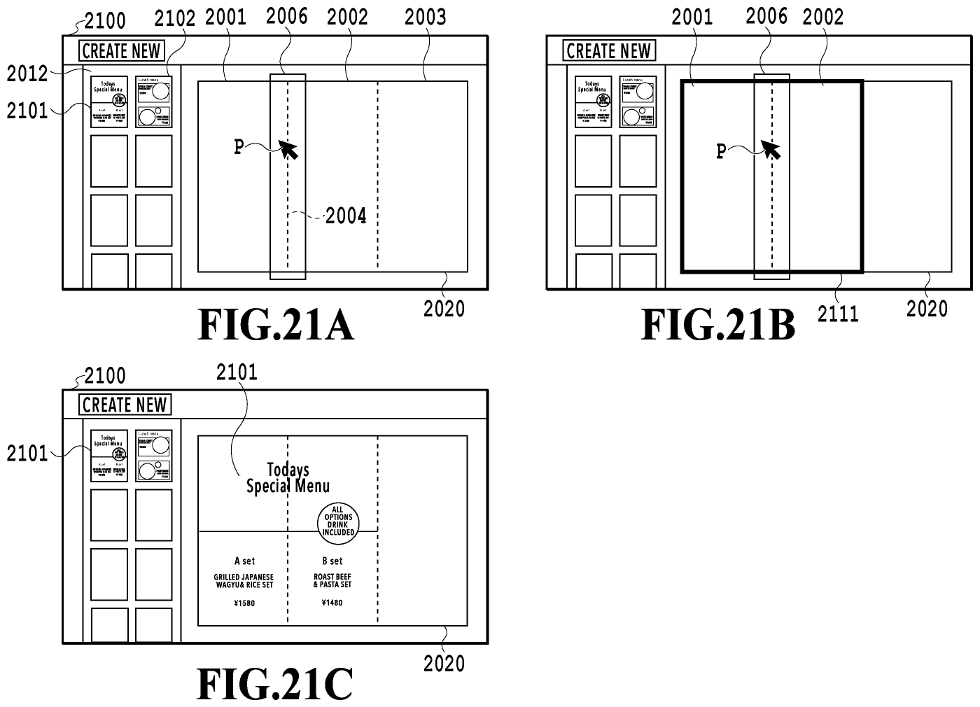

FIG. 21A to FIG. 21C are diagrams showing an operation procedure in a case where multiple folding areas is selected as one area and a template is applied. FIG. 21A to FIG. 21C show an example in which the type of folding designated by the user is the outward folding into three areas. The relationship graph 1806 of the outward folding into three areas is illustrated in FIG. 18C.

FIG. 21A shows the editing screen 2100 in its initial state. In the preview area 2010 of the editing screen 2100 in the initial state, the original document data 2020 is displayed, and in the template selection area 2012, the selectable templates 2101 and 2102 are displayed. Note that, in FIG. 21A to FIG. 21C, the same parts as those illustrated in FIG. 20A to FIG. 20E are denoted with the same signs as in FIG. 20A to FIG. 20E. In the original document data 2020, the multiple folding areas 2001 to 2003 are set, and the left specific operation range 2006 is set above the left folding line 2004. The left specific operational range 2006 is set as valid according to the definition of the relationship graph. Note that, for the sake of explanation, in FIG. 21A and FIG. 21B, only the left specific operation range 2006 which is valid is illustrated, and the right specific operation range 2007 which is set to invalid is omitted.

FIG. 21B is a diagram illustrating a state in which the user selects the first area. In the example of FIG. 21B, the pointer P is within the left folding area 2001 and also within the left specific operation range 2006. Thus, the left folding area 2001 is the first selected area, and the central folding area 2002, which is associated with the left folding area 2001 by the relationship graph 1806, is the second selected area. Further, the area formed by connecting the first selected area 2001 and the second selected area 2002 is selected as the third selected area 2111. The third selected area 2111 is indicated with the bold line in FIG. 21B.

FIG. 21C shows a screen that has transitioned from the state of FIG. 21B to the state in which the first template selected by the user is applied. As illustrated in FIG. 21C, the poster creation application 303 (the CPU 201) applies the template selected by the user to the selected area. FIG. 21C shows, as an example, the state in which the template 2101 is selected and applied to the third selected area 2111 selected in FIG. 21B. The template 2101 has been resized to the size of the third selected area 2111.

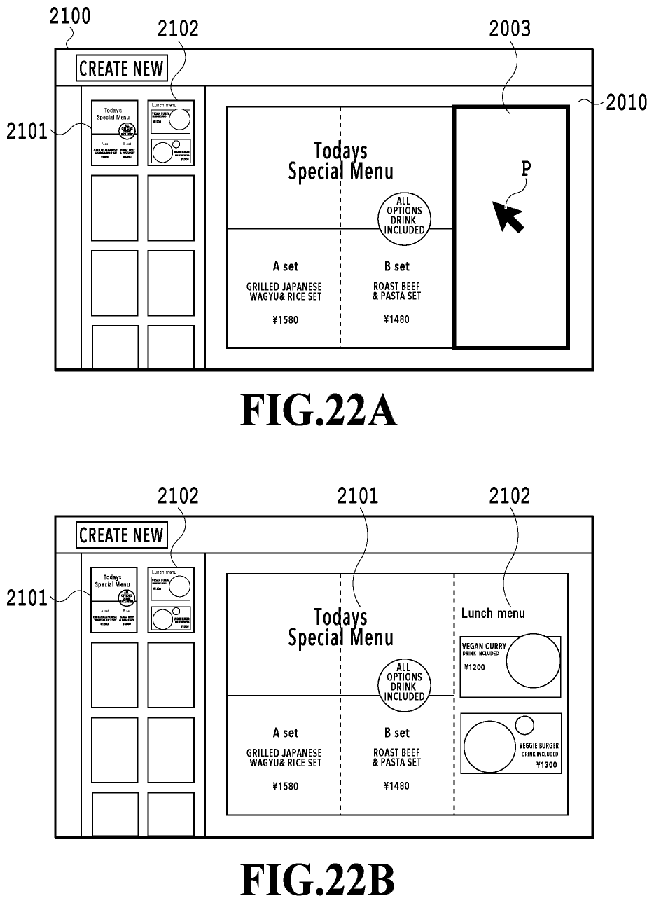

FIG. 22A is a diagram illustrating the state in which the user selects the second area in the state of FIG. 21C. In FIG. 22A, the state in which the right folding area 2003 is selected is illustrated as an example.

FIG. 22B shows a screen that has transitioned from the state of FIG. 22A to the state in which the second template selected by the user is applied. As illustrated in FIG. 22B, the poster creation application 303 (the CPU 201) applies the template 2102 selected by the user to the selected area. In FIG. 22B, the state in which the template 2102 is selected and applied to the folding area 2003 selected in FIG. 22A is illustrated as an example.

By the above-described processing, at the time of creating original document data for a printed material in which multiple areas are formed, multiple areas that are associated with each other based on information regarding a connection of multiple areas can be selected as one connected area, to which any desired template can be applied.

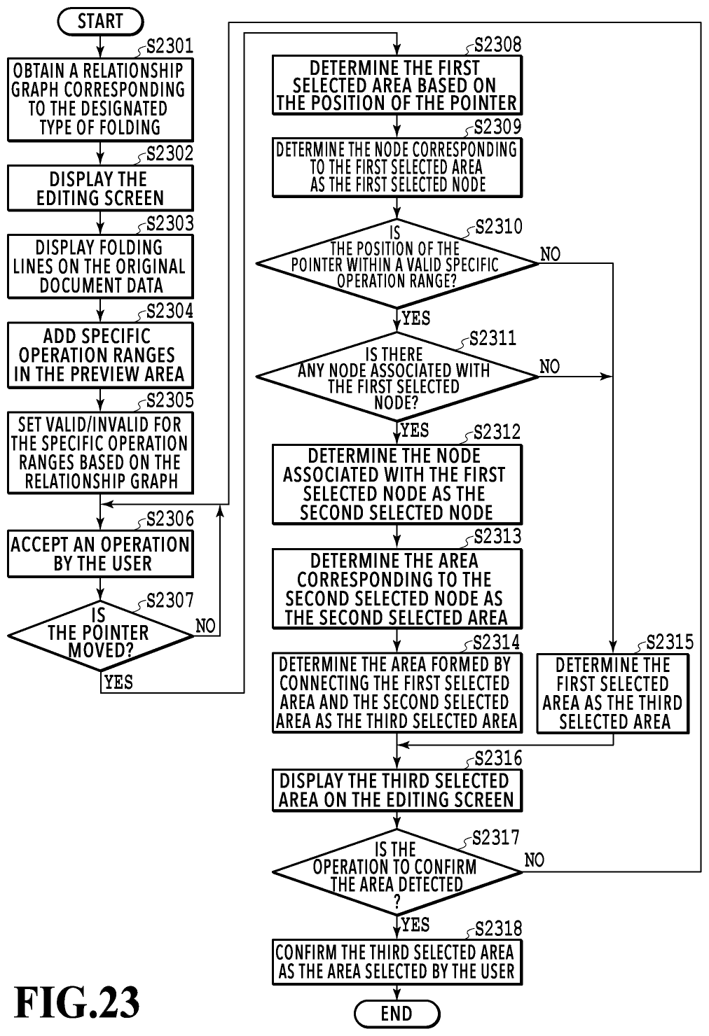

Next, with reference to the flowchart in FIG. 23, an explanation is given of the template application processing executed by the poster creation application 303 (the CPU 201) in the third embodiment. The series of processes shown in FIG. 23 includes a process in which the CPU 201 performs the control for selecting multiple folding areas as one area based on predefined information regarding a connection of multiple areas. Note that the processing shown in FIG. 23 is a flow alternative to S1108 to S1112 of FIGS. 11, and S2301 of FIG. 23 starts at the time the process of S1107 ends. That is, on the printed material setup screen 700 illustrated in FIG. 7, the type of folding and the original document size are selected by the user, and the area ratio of the folding areas and the positions of the folding areas are determined, and in that state, S2301 is started.

In S2301, the CPU 201 obtains a relationship graph corresponding to the type of folding obtained in S1104. The relationship graph is predefined for each type of folding and stored in the storage device 206 of the Web server 102 or the like. Alternatively, the CPU 201 may obtain the relationship graph corresponding to the type of folding from an external Web server via the Internet 103 or the like.

S2302 and S2303 are the same processes as S1108 and S1109, respectively. The CPU 201 displays the editing screen 2100, and displays the folding lines 2004 and 2005 superimposed on the original document data 2020 displayed in the preview area 2010.

In S2304, the CPU 201 sets the specific operation ranges 2006 and 2007 in the original document data 2020 displayed in the preview area 2010. In S2305, the CPU 201 sets whether each of the specific operation ranges 2006 and 2007 is valid or invalid, based on the relationship graph obtained in S2301.

In S2306, the CPU 201 accepts an operation by the user. In S2307, the CPU 201 detects whether an operation of moving the pointer P is performed. In a case where movement of the pointer P is detected, the processing proceeds to S2308, and in a case where movement of the pointer P is not detected, the processing returns to S2306.

In S2308, the CPU 201 determines the first selected area based on the position of the pointer P. That is, the CPU 201 determines the folding area indicated by the pointer P as the first selected area.

In S2309, the CPU 201 determines the node corresponding to the first selected area determined in S2308 as the first selected node.

In S2310, the CPU 201 determines whether the position of the pointer P is inside a valid specific operation range. In a case where it is determined in S2310 that the position of the pointer P is inside a valid specific operation range, the processing proceeds to S2311.

In S2311, the CPU 201 refers to the relationship graph obtained in S2301, and determines whether there is at least one node connected to the first selected node by an edge. In a case where it is determined in S2311 that there is at least one node connected to the first selected node, the processing proceeds to S2312.

In S2312, the CPU 201 determines at least one node connected to the first selected node determined in S2311 as the second selected node. In S2313, the CPU 201 determines the folding area corresponding to the second selected node determined in S2312 as the second selected area.

In S2314, the CPU 201 determines, as the third selected area, the area formed by connecting the first selected area determined in S2308 and the second selected area determined in S2313.

In a case where it is determined in S2310 that the position of the pointer P is not inside a valid specific operation range, or in a case where it is determined in S2311 that there is no node associated with the first selected node, the processing proceeds to S2315. In S2315, the CPU 201 determines the first selected area determined in S2308 as the third selected area.

In S2316, the CPU 201 displays the third selected area determined in S2314 or S2315 on the original document data 2020, which is displayed in the preview area 2010. For example, as illustrated in FIG. 21B, it is preferable that the third selected area 2111 is highlighted with a line type, line thickness, color, or the like that is different from the other lines.

In S2317, whether the operation to confirm the third selected area, such as by a clicking operation on the original document data 2020, is performed by the user is detected. In a case where an operation to confirm the third selected area is detected, the processing proceeds to S2318, and if not detected, the processing proceeds to S2306.

In S2318, the CPU 201 confirms the third selected area determined in S2314 or S2315 as the area selected by the user. Thereafter, the present flowchart ends, and the processing proceeds to S1113 of FIG. 11. The processes after S1113 are the same as those of the first embodiment. That is, the CPU 201 accepts an input of an editing operation by the user, and in a case where a template is selected by the user, the CPU 201 obtains information on the selected template. The CPU 201 resizes the template to match the size of the third selected area confirmed in S2318, and applies it to the third selected area. The template resizing process is performed in the same manner as the processing shown in the first embodiment (FIG. 13 and FIG. 14).

According to the third embodiment, at the time of creating original document data for a printed material in which multiple areas are formed, it is possible to control whether to apply a template to one area or to apply the template across multiple areas, based on information regarding a connection of multiple areas. This allows the user to treat multiple areas as one area in such a way as a double-page spread, or treat each area individually, depending on how the printed material is to be handled in its folded state, and thus it is possible to implement a variety of layouts for printed materials to be folded for use.

Note that, although the examples in which the portrait folding lines divide the printed material in the portrait direction are shown in the above-described first to third embodiments, there is no such limitation, and the present disclosure can also be applied to a case in which landscape folding lines divide the printed material in the landscape direction. Furthermore, the above-described embodiments can also be applied to a case in which a printed material is divided in both the portrait and landscape directions by combining portrait and landscape folding. Additionally, the types of folding are not limited to the examples shown as “FOLD OUTWARD INTO THREE”, “FOLD INWARD INTO THREE”, and “FOLD INTO TWO.” Application to folding into four or more areas such as “Z-folding” and “gate-folding” is also possible. In this case, as in the above-described embodiments, information on the area ratio of the areas and a relationship graph indicating information regarding a connection for the folding are defined according to each type of folding, and stored in a predetermined storage area such as the storage device 206.

Further, although the example in which two edges are set for one node at a maximum is shown in the third embodiment, there is no such limitation to this example, and the number of edges for one node may be three or more. In addition, since the original document data may be designed in various layouts with an increase in the number of folding, it is also possible that multiple relationship graphs are defined for one type of folding. In this case, the user may be able to select the layout of the original document data to be created on the printed material setup screen.

Further, the operation procedures, operation methods, screen configurations, screen display contents, and the like shown in the above-described embodiments are merely examples, and the present disclosure is not limited as such. In addition, although the example in which the terminal device 101 and the Web server 102 are connected via the Internet 103 and the poster creation application 303 is implemented as a Web application is shown in the above-described embodiments, the present disclosure is not limited as such. Implementation as an application executed in a local environment by the terminal device 101 is also possible. At that time, the terminal device 101 may use a portable storage medium in an offline state to obtain the poster creation application program, data necessary for executing the program, template data, and the like. Further, although the example in which the CPU 201 of the Web server 102 executes the processes of each flowchart is shown in the above-described embodiments, it is also possible that the CPU 201 of the terminal device 101 executes these processes.

Although the explanations above are given of the preferred embodiments according to the present disclosure with reference to the accompanying drawings, the present disclosure is not limited to the examples. It is apparent that those skilled in the art can conceive various modification examples or alteration examples within the scope of the technical ideas disclosed in the present application, and it should naturally be understood that those also fall within the technical scope of the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to apply a template to each of multiple areas to be formed on a printed material.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An information processing apparatus comprising:
a setting unit configured to set a plurality of areas to be formed on a printed material in original document data of the printed material;
an accepting unit configured to accept a selection of a target area from among the plurality of areas set in the original document data and a selection of a template to be applied to the target area; and
an applying unit configured to obtain and apply the selected template to the selected target area.

2. The information processing apparatus according to claim 1, wherein the accepting unit further accepts from a user a selection of a type of folding, and wherein the setting unit sets the plurality of areas in the original document data according to the selected type of folding.

3. The information processing apparatus according to claim 1, wherein the applying unit resizes the template to match the size of the target area.

4. The information processing apparatus according to claim 3, wherein the applying unit resizes the template so that a positional relationship among a plurality of objects included in the template before resizing is maintained even after resizing.

5. The information processing apparatus according to claim 1, wherein, in a case when a user performs a second operation, which is different from a first operation that is an operation of selecting one area as the target area, the accepting unit accepts a selection of at least two areas from among the plurality of areas set in the original document data as one connected area.

6. The information processing apparatus according to claim 5, wherein the second operation is an operation of the user designating a given position within a range enclosing a predetermined distance from a boundary position of the plurality of areas set in the original document data.

7. The information processing apparatus according to claim 6 further comprising an obtaining unit configured to obtain information regarding a connection of the plurality of areas,
wherein, based on the obtained information regarding a connection of the plurality of areas and the position designated by the user in the second operation, the accepting unit determines a second area, which is connected to a first area that includes the position designated by the user, and accepts the selection of the target area on the premise that the area formed by connecting the first area and the second area is one area.

8. The information processing apparatus according to claim 7, wherein the information regarding a connection of the plurality of areas is determined based on a positional relationship of the plurality of areas of the printed material in a folded state.

9. The information processing apparatus according to claim 1 further comprising a display control unit configured to display a line indicating a boundary of the plurality of areas set in the original document data so that the line is superimposed on the original document data.

10. The information processing apparatus according to claim 9, wherein the display control unit displays the line indicating the boundary in a display form that differs depending on the shape of folding to be formed in the printed material folded along the line indicating the boundary.

11. The information processing apparatus according to claim 1, wherein the accepting unit further accepts an operation of switching between a first mode, in which the template is applied to the entire original document data, and a second mode, in which the template is applied to the target area selected from among the plurality of areas set in the original document data, and
wherein, in a case where the operation of switching to the second mode is performed, the applying unit applies the selected template to the selected target area.

12. The information processing apparatus according to claim 1, wherein the accepting unit further accepts an operation of switching between a first mode, in which the template is applied to the entire original document data, and a second mode, in which the template is applied to the target area selected from among the plurality of areas set in the original document data, and
wherein, in a case where the operation of switching to the first mode is performed, the applying unit applies the selected template to the entire original document data.

13. The information processing apparatus according to claim 2, wherein the type of folding includes at least any of folding into two areas, folding into three areas, and folding into four areas.

14. The information processing apparatus according to claim 1, wherein the plurality of areas set in the original document data includes areas divided in a portrait direction, landscape direction, or both of the portrait and landscape directions.

15. An information processing method executed by an information processing apparatus, the information processing method comprising:
setting a plurality of areas to be formed on a printed material in original document data of the printed material;
accepting a selection of a target area from among the plurality of areas set in the original document data and a selection of a template to be applied to the target area; and
obtaining and applying the selected template to the selected target area.

16. A non-transitory computer readable storage medium storing a program which causes a computer to execute an information processing method, the information processing method comprising:
setting a plurality of areas to be formed on a printed material in original document data of the printed material;
accepting a selection of a target area from among the plurality of areas set in the original document data and a selection of a template to be applied to the target area; and
obtaining and applying the selected template to the selected target area.
